(19) United States
(12) Patent Application Publication
(10) Pub. No.: US 2006/0010024 A1
(43) Pub. Date: Jan. 12, 2006

(54) System construction guide system

(75) Inventor: Kimikazu Eguchi, Tokyo (JP)

Correspondence Address: Paul J. Esatto, Jr.;Scully, Scott, Murphy & Presser, 400 Garden City Plaza, Garden City, NY, 11530, US

(73) Assignee: NEC Corporation, Tokyo (JP)

(21) Appl. No.: 11/169,051

(22) Filed: Jun. 28, 2005

(30) Foreign Application Priority Data
Jul. 6, 2004 (JP) 2004-199832

(51) Int. Cl. G06F 19/00

(52) U.S. Cl. 705/8; 700/95

(57) ABSTRACT

To provide a system capable of executing a project of constructing a basic system accurately at a lower cost and in a shorter period. There are provided a system construction guide server in which work plan information for constructing a predetermined system is registered, and an operator terminal operated by an operator performing a work to the target system based on the work plan information. The system construction guide server has a function of presenting the work plan information to the target system corresponding to an access from the operator terminal, and the work plan information includes work content information indicating work contents for constructing units constituting the target system.

### BACKGROUND OF THE INVENTION

1. Field of the Invention

The present invention relates to a system construction guide system, and in particular, to a system construction guide system preferable for constructing a large-scale computer system.

2. Related Art

Conventionally, a construction of the basic system of a large-scale core computer system requiring high reliability and high performance is performed mainly by skilled engineers through a trial and error process taking much time for each system project usually at a client's site, while closely contacting non-skilled people and other project members in a non-routine manner for design, manufacturing and evaluation.

As the scale of a computer system to be constructed becomes larger, a work status management is required so as to check whether no work is omitted, for example. Such a management system is disclosed in Japanese Patent Application Laid-open No. 2001-325415 (Patent Document 1).

However, with the conventional method, it takes much time for a system design if it contains many parts where skilled engineers must be involved with. Further, it is difficult to secure personnel, and also an enormous cost is required.

Further, in the current situation where there are increasing demands for constructing a system in a shorter period, dealing with a case where client site may be in the countryside or in a foreign country, and further cost reduction, due to the increased competition and the globalization of the economy, the conventional art causes further problems.

In addition, although the work status is managed so as to realize a precise design work, the art disclosed in Patent Document 1 only manages work items to be performed by operators, so it is difficult for non-skilled engineers to perform the work easily.

Therefore, it is an object of the present invention to provide a system capable of carrying out a project of constructing a basic system accurately in a shorter period and at a low cost.

The present invention is so configured as to include a system construction guide server in which work plan information for constructing a predetermined system is registered, and an operator terminal operated by an operator performing the work to the system, which is the target system, based on the work plan information. The system construction guide server has a work plan information presenting function for presenting the work plan information to the target system corresponding to an access from the operator terminal. The work plan information includes work content information indicating work contents for constructing units constituting the target system.

With such a configuration, an operator is capable of obtaining the work item information indicating the work contents from the system construction guide server by using the operator terminal, and by referring thereto, performing the system construction work on site or online. Thereby, it is possible to construct a system of a certain quality even by non-skilled engineers, without depending on skilled engineers. This enables reduction in the work cost, the work time, and the like.

Further, it is preferable that the work content information included in the work plan information be applicable in common for when a plurality of different units are constructed.

Further, the work plan information may be so configured that pieces of work content information indicating the same work content are grouped so as to set a work plan. For example, the work plan may be set such that units of the same type capable of being constructed with the same work content are grouped. Further, when the target system is constructed by a plurality of server computers, the work plan information may be so configured that server computers of the same type capable of being constructed with the same work content are grouped so as to set a work plan.

With this configuration, a work plan is set beforehand for a plurality of different units, or same unit, or same server computers, capable to be constructed with the same work content. For example, a work plan is set beforehand in which works of the same work content information are assigned to one operator, or to an operator of the same group, and the operator proceeds the work based on the work plan information. This promotes to perform the same work effectively, enabling to reduce the work time and the work cost.

In addition to the above-described configuration, the present invention may be so configured that the target system is connected with the operator terminal over a network, and the operator terminal is capable of performing a construction work to the system, and the operator terminal has a function of performing the construction work to another unit of the same work content based on the work plan information, by using data obtained as a result of performing the work to a specific unit.

Further, the present invention may be so configured that the target system is connected with the operator terminal over a network, and the operator terminal is capable of performing the construction work to the system similarly, and the system construction guide server has a function of acquiring, from the operator terminal or from the target system, and using data obtained as a result of performing the work to a specific unit, and performing the construction work to another unit or server computer of the same work content based on the work plan information.

Thereby, the operator terminal and the system construction guide server perform works to construct units and server computers. The works are performed automatically
based on data of the work results which have been performed to the units and the server computers. Note that the units and the server computers are constructed with the same work contents. Therefore, the operator terminal and the system construction guide server is capable of improving work efficiency without repeating the same work.

Further, since the present invention is so configured that the target system is connected with the operator terminal over a network, and the operator terminal is capable of performing the construction work to the system, it is possible to perform the construction work remotely, whereby the work efficiency is improved.

In addition to the configuration described above, the present invention may be so configured that the operator terminal has a function of transmitting progress status data for reporting a progress status of the work inputted by the operator to the system construction guide server, and the system construction guide server has a work status managing function for managing the progress status data received, based on the work plan information.

Here, the system construction guide server may have a work result data collecting function for collecting data, obtained as a result of performing the work, from at least one of the operator terminal and the target system based on the progress status data, when receiving the progress status data.

Thereby, since input of the progress information of the project management is performed on site along with the progress of the work, the progress data is not required to be inputted separately, whereby it is possible to suppress deviations from the current status caused by the delay of the data input timing. That is, the operator is capable of performing the work while recognizing deviations from the schedule, and the project manager is capable of recognizing accurate progress with specifications at work levels. Further, when a trouble is caused, the content thereof can be managed on the server side.

In addition to the configurations described above, the present invention may be so configured that the operator terminal has a function of transmitting inquiry data indicating an inquiry content relating to the work inputted by the operator to the system construction guide server, and the system construction guide server has a function of transmitting the inquiry data received to another server connected over a network and requesting a response to the content of the inquiry data.

Thereby, when a question arises relating to the work content, the operator can transmit inquiry data and obtain a response from another server via the system construction guide server. This enables to speed-up the construction work.

Moreover, the present invention also provides a system construction guide server and operator terminals for constructing the system construction guide system, a program for controlling their operations, and a system construction guiding method.

A system construction guide server of the present invention is a server in which work plan information for constructing a predetermined system is registered, which includes function of presenting the work plan information to the target system corresponding to an access from the operator terminal connected over a network, and the work plan information is information based on which an operator operating the operator terminal perform a work to the target system, and includes work content information indicating work contents for constructing units constituting the target system.

Further, a program for controlling the operation of the system construction guide server is a program for realizing the functions described above in the system construction guide server.

Further, an operator terminal is connected over a network with a system construction guide server in which work plan information for constructing a predetermined system is registered, and is operated by an operator performing a work to the target system based on the work plan information. The operator terminal is so configured to have a work plan information requesting function for requesting for the work plan information to the target system by accessing the system construction guide server and receiving it, and the work plan information includes work content information indicating work contents for constructing units constituting the target system.

A program for controlling the operation of the operator terminal is a program for realizing the functions described above in the operator terminal.

Further, a system construction guiding method is a method for performing a system construction by using a system construction guide server in which work plan information for constructing a predetermined system is registered, and an operator terminal connected with the system construction guide server over a network. The method is so configured as to include: a work plan requesting step in which the operator terminal requests for the work plan information to the system construction guide server; a work plan information presenting step in which the system construction guide server presents the work plan information with respect to the target system corresponding to a request from the operator terminal; and a construction work step in which the operator terminal performs a work with respect to the target system connected over a network based on the work plan information presented. The work plan information includes work content information indicating work contents for constructing units constituting the target system.

With the configuration described above, the method is capable of acting as same as the system construction guide system, and a similar effect can be achieved. Thereby, it is possible to achieve the object described above.

(Effect)

The present invention is configured and works as described above. Thereby, an operator is capable of acquiring work content information indicating the work contents from the system construction guide server by using the operator terminal, and performing the work for the system construction, by referring thereto, on site or online. Accordingly, it is possible to construct a system of a certain quality even by non-skilled engineers, without depending on skilled engineers. This provides such an excellent effect of reducing the work cost and the work time, which could not be expected conventionally.

### BRIEF DESCRIPTION OF THE DRAWINGS

FIG. 1 is a block diagram showing the configuration of the whole system of the present invention;

FIG. 2 is a functional block diagram showing the configuration of a system construction guide server;

FIG. 3 is an illustration showing the relationships between units and work items;

FIGS. 4A and 4B are illustrations each of which shows a state of loading data between a system construction server and a project management system;

FIG. 5 is an illustration showing an exemplary screen displayed on an operator terminal, indicating a work start screen;

FIG. 6 is an illustration showing an exemplary screen displayed on the operator terminal, indicating a work item selection screen;

FIG. 7 is an illustration showing an exemplary screen displayed on the operator terminal, indicating a work content screen;

FIG. 8 is an illustration showing an exemplary screen displayed on the operator terminal, indicating a trouble countermeasure search screen;

FIG. 9 is an illustration showing an exemplary screen displayed on the operator terminal, indicating a memorandum screen;

FIG. 10 is a flowchart showing the state when data is registered; and

FIG. 11 is a flowchart showing the state when an operator performs a work.

### PREFERRED EMBODIMENT OF THE INVENTION

The characteristics of a system construction guide system of the present invention lie in the following aspects. That is, first, data indicating work contents for constructing a system which is the target system is presented to an operator, based on which the operator performs the work, whereby it is possible to perform the system construction easily. Secondly, a work plan is set such that tasks of the same work content are grouped, whereby the work becomes more efficient. Thirdly, it is possible to recognize the work status on the system construction guide system side, whereby the management can be performed easily.

In order to realize the above-described characteristics, in the present invention, work contents for construction are developed for each project by associating with project management software and the like, based on a system model which is modeled using combinations of proved products. Thereby, operators, mostly non-skilled engineers, can construct the target system by easily performing work contents assigned to themselves over networks, up to input of progress data. The configuration for realizing the above-described characteristics will be described below in detail.

### First Embodiment

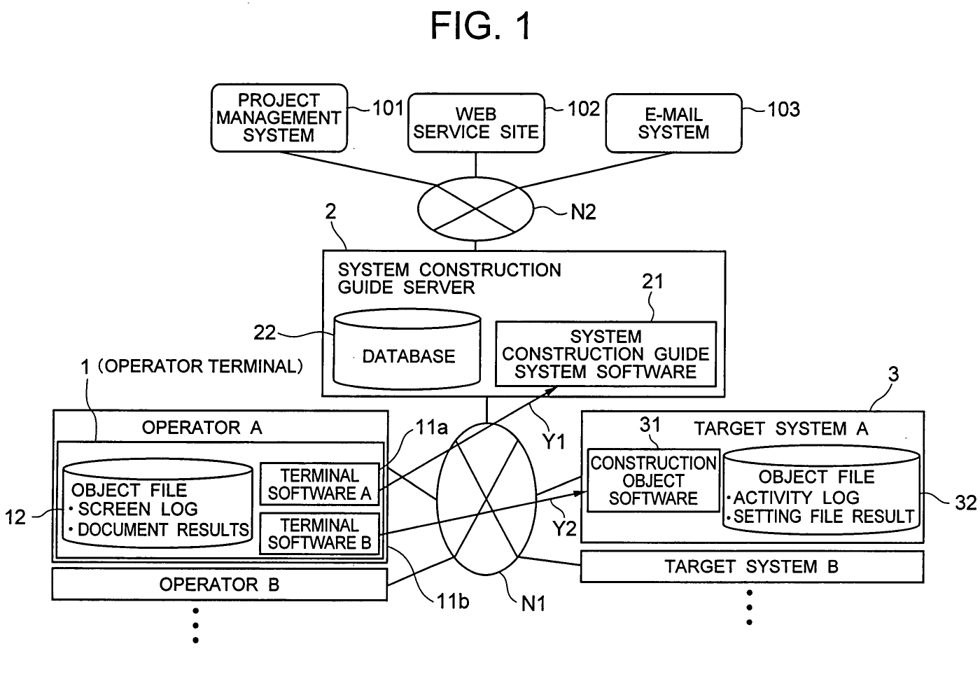

A first embodiment of the present invention will be described with reference to FIGS. 1 to 11.

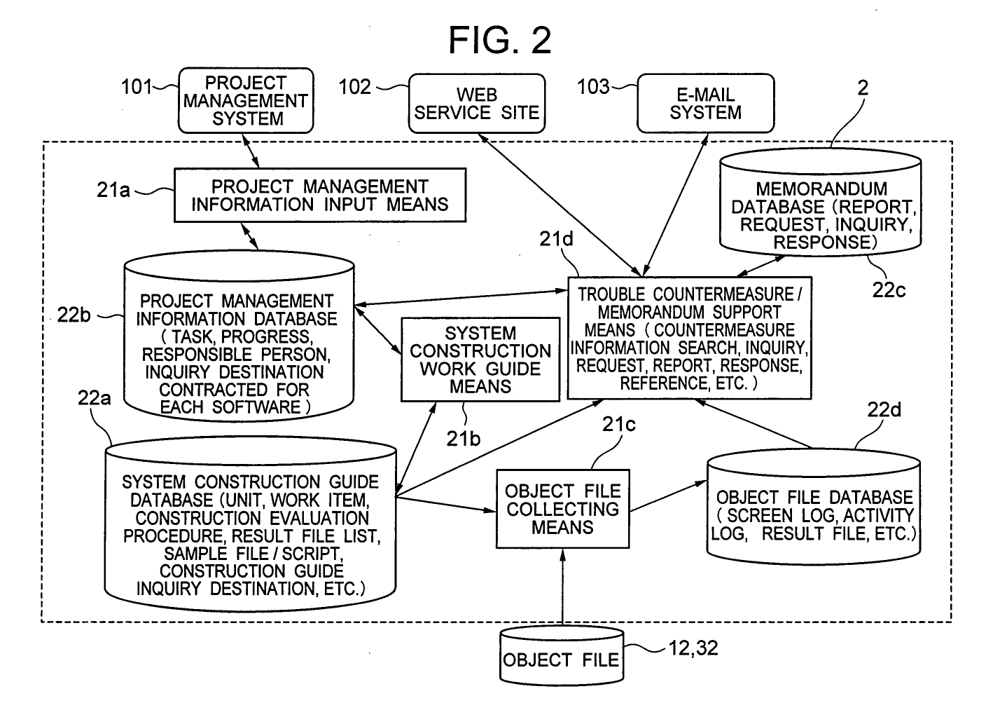

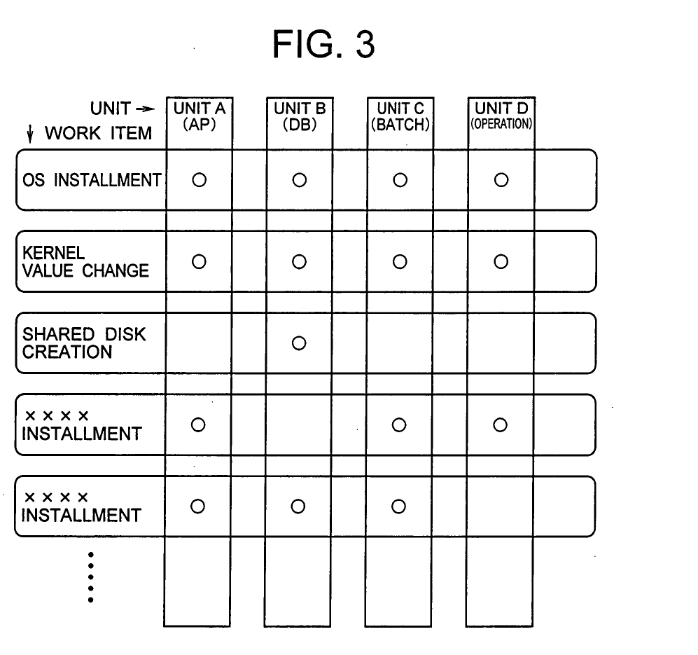

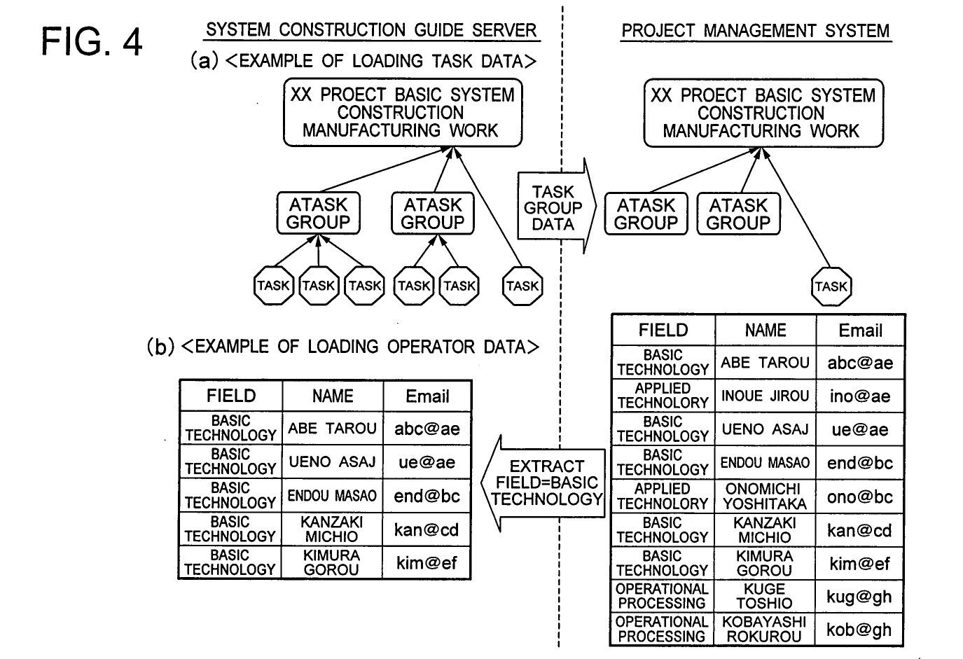

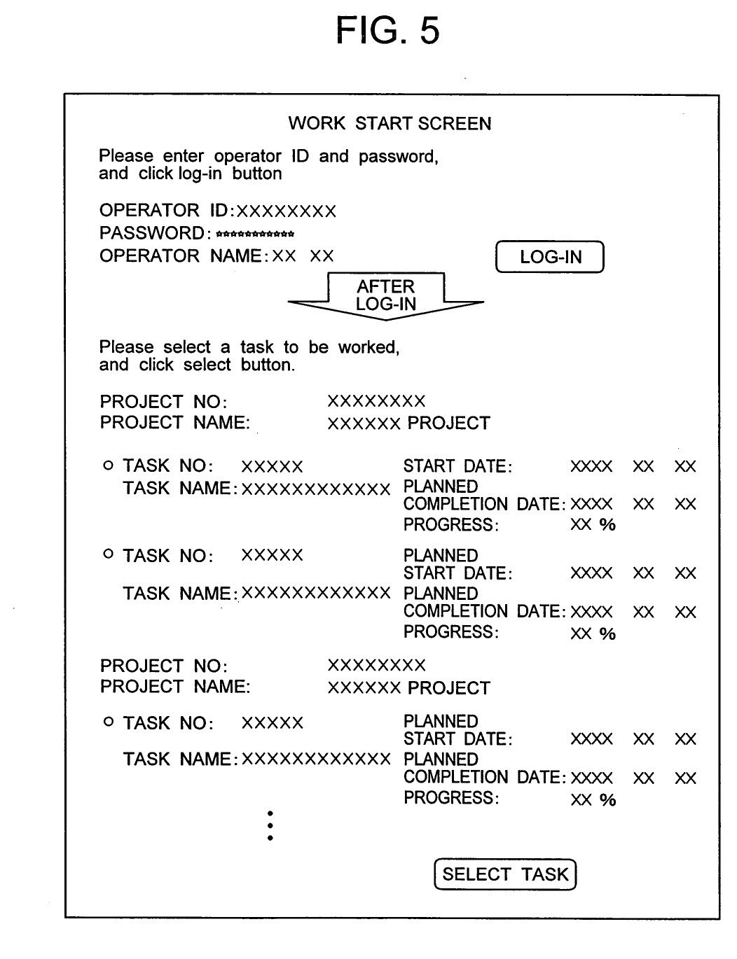

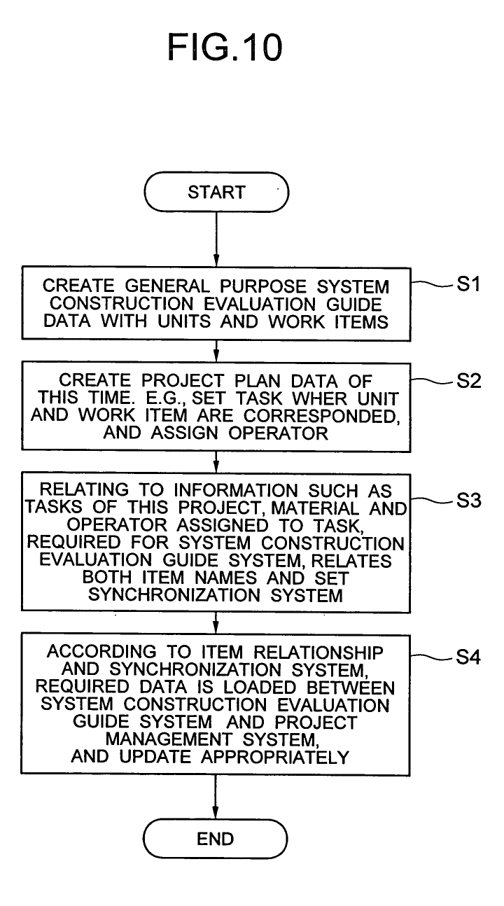

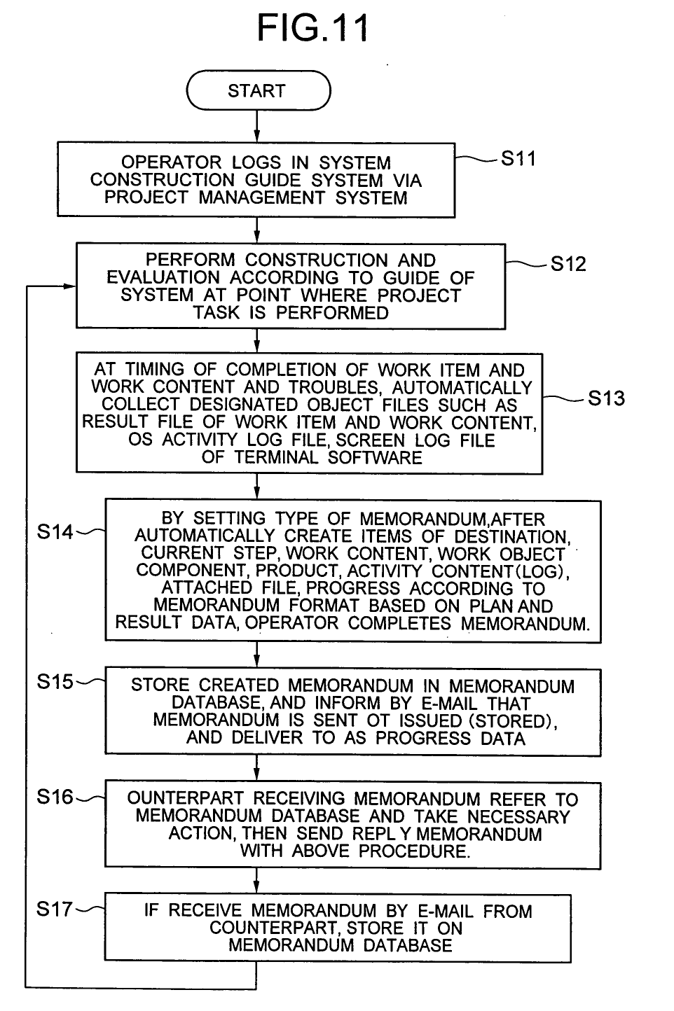

FIG. 1 is a block diagram showing the configuration of the overall system construction guide system. FIG. 2 is a functional block diagram showing the configuration of a system construction guide server. FIGS. 3 to 4B are illustrations showing the configuration of data used in the present invention. FIGS. 5 to 9 are illustrations showing exemplary screens displayed on an operator terminal. FIGS. 10 and 11 are flowcharts showing the operation.

(Overall Configuration)

As shown in FIG. 1, the system construction guide system according to an embodiment of the present invention includes a system construction guide server 2 in which work plan information for constructing a predetermined system is registered, and an operator terminal 1 operated by an operator performing the work to the target system based on the work plan information. They are connected over a network N1 such as the Internet or an intranet. Further, a system 3 which is the target of the construction work is connected with the system construction guide server 2 and the operator terminal 1, over the network. Further, the system construction guide server 2 is connected with a project management system 101 in which project management software and the like associated therewith are installed, a web service site 102 such as a search engine and a software vender, and an E-mail system 103, over a network N2 such as the Internet or an intranet.

The networks N1 and N2 may be the same. Further, if the networks N1 and N2 are the Internet, it is preferable to take security measures such as VPN, as required. Each configuration will be described below in detail.

(System Construction Guide Server)

The system construction guide server 2 is a typical server computer having a function of setting up a website, and in particular, having a function of providing a method of constructing a system base of high reliability and high performance based on the system model, and a method of supporting resolution when troubles are caused. The server 2 incorporates system construction guide system software 21, and operates to present work plan information stored on a database 22 to the operator. The system construction guide server 2 will be further explained in detail referring to FIG. 2.

Hereinafter, the works for constructing one system is called a project, and a group of works, organized so as to be assigned to an operator or operators to be performed within a certain period and organized with an intention of managing the progress later in the project, is called a task. Further, a unit of constituting the target system is called a “unit”. There are a plurality of hard wares relating to each unit, and a task is configured for each hard ware. However, a configuration method of a task is not limited to the one described above. For example, one unit may constitute one task.

In the system configuration guide server 2, data created by the project manager or the like is stored as described below. A method of creating the data and the like will be explained in detail.

First, a system model, which is a model of the system to be constructed, is created. This is performed by: analyzing historical performance of constructing large-scale systems of high reliability and high performance and requirements of a new client; defining function domains, that is, units, of a basic system level other than the operational logic; combining them according to the classification of the operational processing patterns of the system; and defining, installing and verifying the combination of actual basic products required for realizing the respective units, to thereby create a system model incorporating work items (work content information) indicating the sequence and the work contents for constructing the units, operating procedures after service, a sizing method for defining the size of the system model, and tools required for installation.

Here, as shown in FIG. 3, the work items (work content information) indicating the construction work of the units are considered as a matrix of units, in which the same work item such as installing of a component product is designed so as to be applicable to the respective units in common. Here, work items corresponding to the respective units are stored on a system construction guide database 22a in the system construction guide server 2. Further, work items are divided into those accompanying operations of media or hard wares and those must be performed on site such as an installment of the operating system, and those can be performed remotely, if appropriate.

Next, a determination whether the system model is applicable in the project, and a corresponding work such as a partial addition are performed. Before starting the actual project to which the present system model is applied, it is found out whether an operational processing pattern required by the client is practicable by a specific system model. If it is possible to cope with by improving partially or by adding a unit partially, such a part is incorporated into the system model.

Next, sizing work is performed. A definition of scale is performed in accordance with a sizing method defined for each system model. The number of servers required for each unit, the number of products required for each unit, and all parameter samples required for installing them are defined. Then, it is incorporated in the work contents such that a parameter sample of a product such as each server of each unit defined in the sizing is installed in each product.

Then, a detail plan determination work of a project task is performed. In many cases, the same work content (operational procedure) is repeatedly performed for the number of hardware such as servers of the applying unit, and each result derived therefrom is defined as a task. If appropriate, a plan is set by taking into account efficient work contents such that tasks of the same work may be grouped by work item, by server unit, or by their combination, and work items are set thereto, which are performed automatically. For example, a plan is determined so as to set an operator for each work content information (work content) indicating the same work content (procedures) More specifically, a work plan is set such that units of the same kind or server computers of the same kind for the same construction work are grouped, which are assigned to one operator. The work plan set in this way is stored on the project management information database 22b in the system construction guide server 2.

Based on the work plan stored on the project management information database 22b, work content information of each task for each operator is provided from the system construction guide database 22a to the operator terminal 1. Since the work content information includes installment procedures of the products and their confirmation, and information for performing performance evaluation after installment, the operator is capable of performing the work easily by referring to the work content information (work items). Further, it is also possible to complete the construction up to the base system level except for the operational level.

Here, information stored on the system construction guide database 22a and information stored on the project management information database 22b are called and treated in combination as work plan information.

Next, the information stored on the project management information database 22b is delivered to the project management system 101, and is managed in common. However, if the project management system does not have a management accuracy of this level, the task level is managed solely in the present method, which is managed in common only by a task group grouped in a larger size than the unit, the work item, or the work item/unit. Further, an operator on site or at a remote area is assigned to each task, and the schedule is also created based on the average manpower and the sequence of each operational item.

Further, in a case where works are managed in common with the project management software only up to a task group level, a task level is managed solely. As a common management, all operators belonging to the group are managed as the operators of the task group. There may be a case where assignment of operators and creation of the schedule is performed in the project management software.

Further, as shown in FIG. 2, the system construction server 2 also includes a memorandum database 22c and an object file database 22d. Data stored thereon will be described later.

Next, functions of the system construction guide system software 21 installed in the system construction guide server 2 will be explained. In the CPU of the system construction guide server 2, a predetermined program is installed, whereby respective processors 21a to 21d described below are constructed.

First, in the CPU, a project management information input/output means 21a for associating the project management system 101 with the project management information database 22b is constructed, as described above. Further, a system construction work guide means 21b, having a function of presenting work plan information with respect to the system 3 which is the target system of the operator corresponding to an access from the operator terminal 1, is also constructed.

Further, in the CPU, there is constructed an object file collecting means 21c having a work status management function for managing progress status data received from the operator terminal 1 based on the work plan information. Thereby, at each juncture of the work content or at the end of a work item, each time a confirmation is inputted from the operator terminal 1, or at regular timing, the progress rate or the like for each task or task group of managing the collected progress data in the project is converted into a content manageable by the project management software and is reflected in the project management software. Further, the object file collecting means 21c has a work result data collecting function for collecting data obtained as a result of performing the work from at least one of the operator terminal 1 and the target system 3 based on the progress status data when the progress status data is received. Thereby, the collected data is stored on the object file database 22d temporary.

Further, the CPU includes a trouble countermeasure/memorandum support means 21d having a function of transmitting inquiry data received from the operator terminal 1 to a response server registered beforehand and requesting for a response to the problem. Then, the inquiry data transmitted from the operator terminal 1 by this means, response data obtained by inquiring to another system and the like are stored on the memorandum database 22c. Then, the memorandum database 22c is also possible to serve as past Q&A data, as a means for solving troubles by the operator. Accordingly, when a memorandum is received, the data therein is classified by the content, and the results, screen logs and activity logs in the work at the time are collected and stored in the database similarly. Further, responses from another server to the inquiry are also classified and stored on the database similarly.

The object file collecting means 21c further has a function of performing a construction work to units or server computers of the same work procedures based on the work plan information, by using data obtained as a result of performing the work to a specific unit or server computer. Specifically, the object file collecting means 21c has such a function that if it is recognized that the same work item is repeatedly performed for each unit or each server based on the work plan information in the system construction guide server 2, a construction work described below is automatically performed to the second and successive units or servers. For example, if there is a server or the like that the setting contents for one hardware product such as a server is completely the same, a means such as a volume copy or a copy in a hardware system memory is used, although the work may be performed on site. Alternatively, if there is a server or the like where the work contents of one work item or a group of work items which can be performed by continuing procedures are the same, the operation is automatically performed in the second and successive servers by using the screen logs collected in the first server. Further, if it can be done by copying a directory and a file, the directory and the file which have been set in the first server or the like are copied to the second and successive servers or the like. These operations may be performed manually by the operator. Such a function may be provided to the operator terminal 1 which will be described below in detail.

(Operator Terminal)

Next, the configuration of the operator terminal 1 will be explained. Here, an operator terminal 1 held by an operator A in FIG. 1, among a plurality of operator terminals 1, will be explained.

The CPU of the operator terminal 1 mainly incorporates two terminal software 11a and 11b. The operator uses the software to thereby perform a construction work. Specifically, the operator uses the terminal software A 11a to access a website set up by the system construction guide server 2, over the network N1 (see arrow Y1), and refers to the website by operating the system construction guide system software. At the same time, the operator uses the terminal software B 11b to operate the construction object software 31 of the target system 3 over the network N2 (see arrow Y2), to thereby create an object file 32 composed of the results such as setting files and activity logs. Further, during the process, an object file 12 composed of screen logs and document results is created on the operator terminal 1.

Further, the operator has a function of inputting progress data of the project on the operator terminal 1, and transmitting the progress status data reporting the progress status of the work to the system construction guide server 2. For example, when the operator performs the work in accordance with the work procedure, an item of checking at junctures of the work is included, and the work is proceeded while marking for confirmation is performed by clicking the screen. In this way, it is set that the operator can input the progress data during the work. Note that this input becomes easy for the operator when the input screen is displayed on the operator terminal 1 by the system construction guide system software 21 installed in the system construction guide server 2.

Further, the operator has a function of transmitting inquiry data indicating inquiries (problems, etc), which arises during the work, inputted by the operator during the work or after the work to the system construction guide server 2. The data transmitted is stored on the memorandum database 22c, and is also made into an E-mail by an E-mail system 103, and is inquired to a web service site 102 such as a search engine and a software vender. Then, a response may be obtained from another site, and is returned to the operator terminal 1, whereby an early resolution can be realized.

(Operation)

Next, the operation of the present invention will be explained with reference to FIGS. 4A to 11. FIGS. 4A and 4B are illustrations showing the data loading operation between the system construction guide server 2 and the project management system 101. FIGS. 5 to 9 are illustrations showing operational screens displayed on the operator terminal 1 accessing the system construction guide server 2. FIGS. 10 and 11 are flowchart showing the operation of the system.

First, by referring to the flowchart in FIG. 10, the operation of creating the system construction guide database 22a and the project management information database 22b, which are data stored on the system construction guide server 2 by the project manager or the like, will be described.

First, general purpose data of the system construction guide database 22a, consisting of units and work items, is created. In this creation, a system construction method based on the system model is used (step S1). Note that the relationships between units and work items are as shown in FIG. 3 as described above, and the work items are used in the multiple units in common.

Next, plan data for each project is created in the project management information database 22b (step S2). First, the scale of the system model is set by sizing. Thereby, samples of the number of servers for each unit and setting data set to each server or the like are obtained. Secondly, the work items are developed to works for each server of the unit, that is, to the minimum unit of task. Then, works to be performed repeatedly for each server are grouped by the server unit or the work item unit, and a group of works, which can be automated, is applied with automated work items, to thereby create an optimized task structure. At this time, the group of works is assigned to one operator, for example. Thirdly, the task created here is loaded in the project management system 101, and the data such as the operator (responsible person) and the inquiry destination contracted for each software to be used in the project management system 101, is loaded in the system construction guide server 2 (step S3).

Here, synchronization of data in the system construction guide server 2 and the project management system 101 is performed by the project management information input/output means 21a. This means 21a works to load data existing in one system but not existing in the other system into the system where the data does not exist, and then, to update the data at the designated timing automatically (step S4). As a result, the data in the project management system 101 is kept in the latest state via the project management information input/output means 21a, the data being overlapped with the project management information database 22b. An example of the data loading relationship between the both systems is shown in FIGS. 4A and 4B. In these Figures, data stored on the system construction guide server 2 is shown on the left side, and data stored on the project management system 101 is shown on the right side. In an example of loading task data shown in FIG. 4A, in the project management system 101, only a manufacturing work is defined as a large task among the base system construction tasks of the XX project, and tasks of lower levels do not exist. However, the lowest task level is not required, and it is accepted that the management is performed down to the task group level. Therefore, data of the task group level, under the parent data of the task of the manufacturing work to which the system construction guide server 2 corresponds, is loaded in the project management system. The third task from the left is loaded as it is, since it has no task group. Further, an example of loading operator data shown in FIG. 4B shows a state where the operator data is loaded from the project management system 101 since the system construction guide server 2 does not have the operator data. At this time, only data for the basic technology field is extracted and loaded.

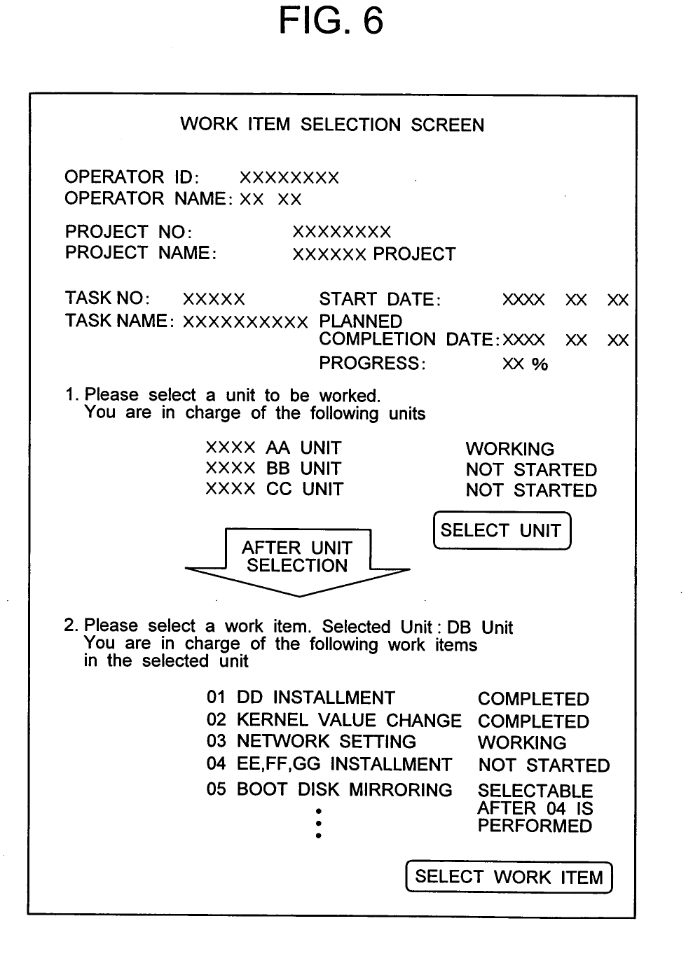

Next, an example that an operator performs a system construction work will be explained by referring to FIG. 11. First, the operator logs in the system construction guide system (S11). Here, the operator may set up the project management system 101 and select his task before the login, or may set up the system construction guide system directly. FIG. 5 shows an exemplary screen when the operator directly logs in the system construction guide system. This screen is displayed on the operator terminal 1 while the data is transmitted from the system construction guide server 2. As shown in FIG. 5, when the operator logs in, a list of tasks assigned in the project currently dealing with is displayed, and planed start date and completion date and the progress status are also displayed. When the operator selects a task among the tasks, a screen shown in FIG. 6 is displayed.

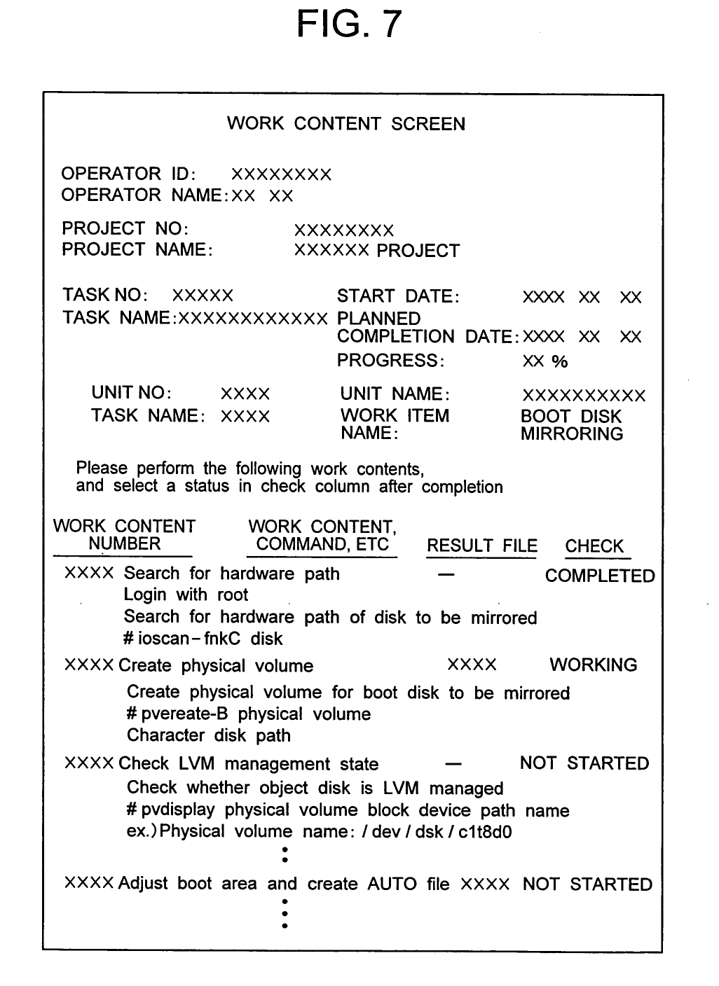

Examples of screens for selecting work items and work contents are shown in FIGS. 6 and 7. As shown in FIG. 6, units of the selected task are displayed. When the operator selects a unit to be worked on the screen, more specific work items are displayed. Then, if the operator selects one currently working or one not yet started, a work content screen shown in FIG. 7 is displayed. In this screen, the work contents (including commands used in the work) indicating the work procedures of each unit are displayed. Base on this, the operator performs the work to the target system 3 and also performs evaluation of the work results (step S12). On the screen shown in FIG. 7, the operator also inputs progress data as the work progresses.

Then, each time a work ends, data indicating the work completion is transmitted from the operator terminal 1 to the system construction guide server 2. Upon receiving the data, the server 2 collects the progress data inputted in the operator terminal 1 (step S13). At this time, data such as a result file created is also collected. The collection is performed at timing when a work is completed or a trouble is caused. The progress data collected by the system construction guide server 2 is, in particular, transmitted to the project management system via the project management information input/output means 21a. Further, by the object file collecting means 21c of the system construction guide server 2, screen logs, activity logs, result files and the like are collected in the object file database 22d from the operator terminal 1 or the object files 12, 32 of the target system 3. Note that the operation of collecting the object files may be performed at any timing and by any operation of the computer.

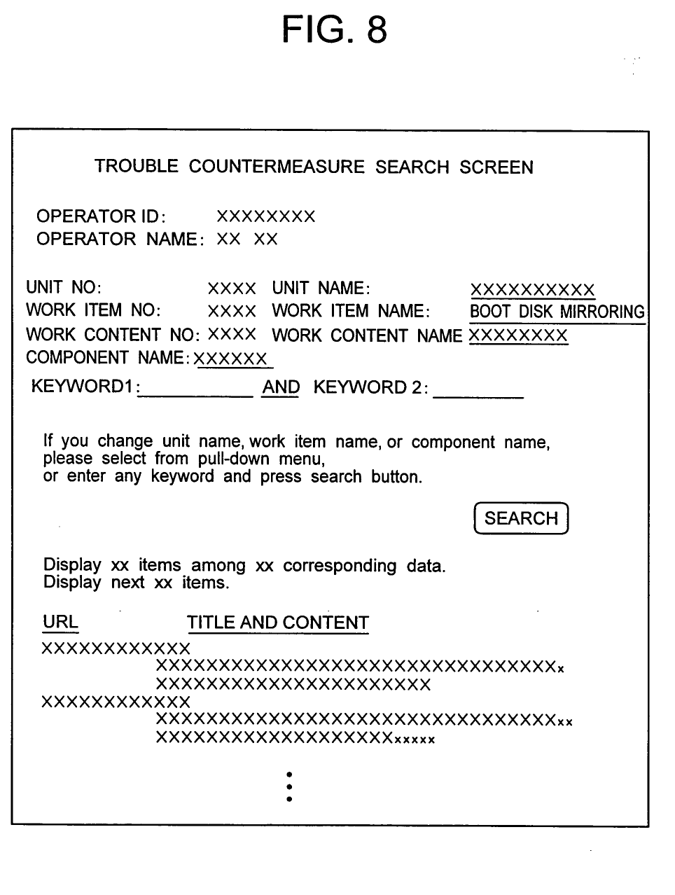

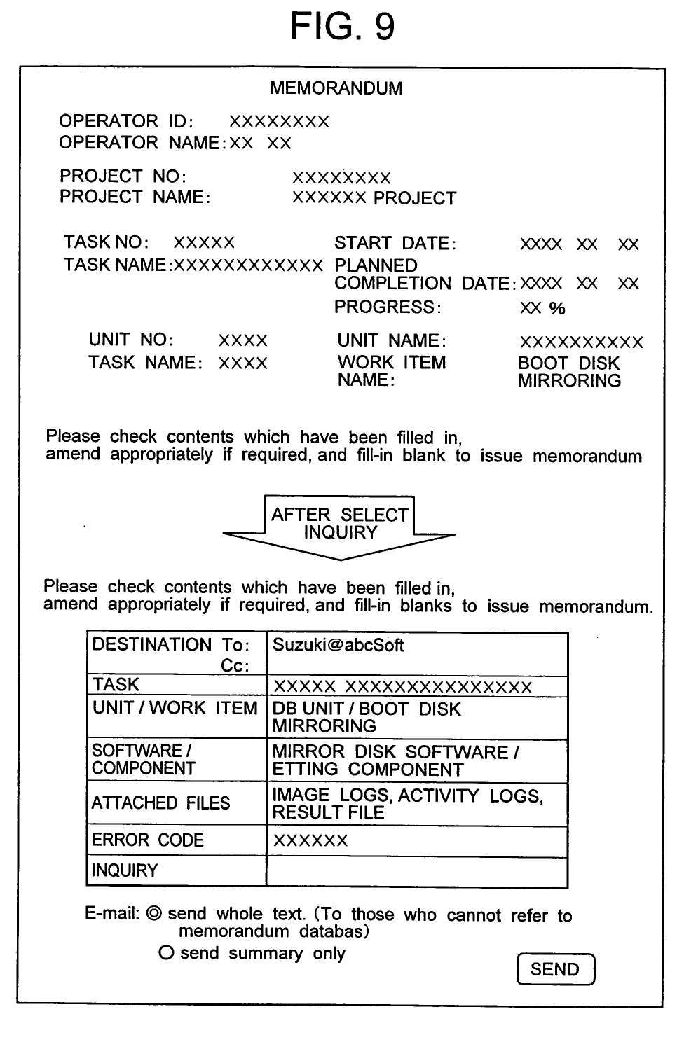

FIG. 8 shows an exemplary screen displayed when trouble countermeasure information is searched, and FIG. 9 shows an exemplary screen for creating a memorandum of inquiry, as a result thereof. These are shown on the operator terminal 1 by the act of the trouble countermeasure/memorandum support means 21d of the system construction guide server 2. In the example of the trouble information search screen shown in FIG. 8, the memorandum database 22c is searched by using a unit number, a work item number, a work content number, a component name and a keyword, and then the results are displays. Further, as for the component name and the keyword, the search results obtained from web service sites 102 such as outside search engines and software vendors are also displayed.

Then, when the operator sets the type of memorandum from the terminal 1, items such as a destination, a current step, a work content, a work object component, a product, an activity content (logs), attached files, and a progress are created automatically. Then, a memorandum shown in FIG. 9 is completed by the operator (step S14). The operator can modify it as appropriate by deleting unnecessary information or changing expressions, according to a person to whom he reports the work status (e.g., manager or other operators), whereby time required for explaining the background and the status can be suppressed to the minimum. At the time of transmission, the item number is automatically adopted, which is inputted in the title and the text, and then the memorandum is transmitted. Also, inquires, arising during the operation, can be inputted.

Next, the created memorandum is stored on the memorandum database 22c in the system construction guide server 2. The fact that the memorandum is sent or issued (stored) is notified to other operators via the web service site 102 and the E-mail system 103, and the memorandum is delivered to the project management system 101 and the like as progress data (step S15).

The web service site 102 and other operators, who received the memorandum, refer to the memorandum database 22c, and after taking necessary actions, transmit a response memorandum. When responding by E-mail, a response E-mail is sent by a reply (step S16).

Then, if the memorandum is received by E-mail from the counterpart, the memorandum is stored on the memorandum database by using the item number as a key, if any in the title or in the text, adopted when sent, by the trouble countermeasure/memorandum support means 21d (step S17).

In this way, the operator is capable of viewing the work item information indicating the work procedures on the terminal, and based on the information, performing the system construction work on site or online. Thereby, it is possible to construct a system of a certain quality without depending on skilled engineers. This enables reduction of work cost and work time, and enables a remote operation. At this time, the operator performs the work according to instructions of the system, and can refer to the past history of the work that he is responsible for, whereby change of operator and handover of work can be performed easily.

Further, a work plan is set in advance such that a plurality of different units or same units or same server computers can be constructed in the same work procedures. For example, each of the work item information, work plan is assigned to the same operator, or assigned to an operator of the same group. Thereby, it is possible to make the same operations effective, resulting in reduction in work time as well as reduction in work cost. In particular, it is configured that the construction work is performed automatically to the same unit or the same server computer which has performed the work, by copying the data of the work result which has been performed once, for example. Therefore, it is possible to further improve the work efficiency.

Further, since input of the progress information of the project management is performed on site along with the progress of the work, the progress data is not required to be inputted separately, whereby no difference from the current status is caused due to the delay of the data input timing. The operator is capable of perform operation while recognizing deviations from the schedule. The project manager is capable of recognizing accurate progress with specifications at work levels. Further, when an operator encounters a trouble, the problem can be solved easily and in a shorter period.

### INDUSTRIAL APPLICABILITY

The system construction guide system of the present invention can be used in such fields of constructing the base system of a large-scale core computer system requiring high reliability and high performance, in particular, in performing a system development of a remote user site, and a system development utilizing remote subcontractors who are in the countryside or foreign countries such as India. Therefore, the present invention is industrially applicable.

What is claimed is:

1. A system construction guide system, comprising:
a system construction guide server in which work plan information for constructing a predetermined system is registered; and
an operator terminal operated by an operator performing a work to the predetermined system, which is a target system, based on the work plan information, wherein
the system construction guide server has a function of presenting the work plan information to the target system corresponding to an access from the operator terminal, and
the work plan information includes work content information indicating work contents for constructing units constituting the target system.

2. The system construction guide system, as claimed in claim 1, wherein the work content information included in the work plan information is applicable in common when a plurality of different units are constructed.

3. The system construction guide system, as claimed in claim 1, wherein the work plan information is so configured that pieces of work content information indicating a same work content are grouped so as to set a work plan.

4. The system construction guide system, as claimed in claim 3, wherein the work plan information is so configured that units of a same type capable of being constructed with a same content are grouped so as to set the work plan.

5. The system construction guide system, as claimed in claim 3, wherein the target system is constructed by a plurality of server computers, and the work plan information is so configured that server computers of a same type capable of being constructed with a same content are grouped so as to set the work plan.

6. The system construction guide system, as claimed in claim 4, wherein the target system is connected with the operator terminal over a network, and the operator terminal is capable of performing a construction work to the system, and
the operator terminal has a function of, by using data obtained as a result of performing the work to a specific unit, performing the construction work to another unit of the same work content based on the work plan information.

7. The system construction guide system, as claimed in claim 4, wherein the target system is connected with the operator terminal over a network, and the operator terminal is capable of performing the construction work to the system, and
the system construction guide server has a function of acquiring, from the operator terminal or from the target system, and using data obtained by the operator terminal as a result of performing the work to a specific unit, and performing the construction work to another unit of the same work content based on the work plan information.

8. The system construction guide system, as claimed in claim 5, wherein the target system is connected with the operator terminal over a network, and the operator terminal is capable of performing the construction work to the system, and
by using data obtained as a result of performing the work to a specific server computer, the operator terminal has a function of performing the construction work to the server computer of the same work content based on the work plan information.

9. The system construction guide system, as claimed in claim 5, wherein the target system is connected with the operator terminal over a network, and the operator terminal is capable of performing the construction work to the system, and
the system construction guide server has a function of acquiring, from the operator terminal or from the target system, and using data obtained by the operator terminal as a result of performing the work to a specific server computer, and performing the construction work to another server computer of the same work content based on the work plan information.

10. The system construction guide system, as claimed in claim 1, wherein the target system is connected with the operator terminal over a network, and work processing is able to be performed from the operator terminal.

11. The system construction guide system, as claimed in claim 1, wherein the operator terminal has a function of transmitting progress status data for reporting a progress status of the work inputted by the operator to the system construction guide server, and
the system construction guide server has a work status managing function for managing the progress status data received based on the work plan information.

12. The system construction guide system, as claimed in claim 11, wherein the system construction guide server has a work result data collecting function for collecting data obtained as a result of performing the work from at least one of the operator terminal and the target system based on the progress status data, when receiving the progress status data.

13. The system construction guide system, as claimed in claim 1, wherein the operator terminal has a function of transmitting inquiry data indicating an inquiry content relating to the work, inputted by the operator, to the system construction guide server, and
the system construction guide server has a function of transmitting the inquiry data received to another server connected via a network, and requesting a response to the inquiry content of the inquiry data.

14. A system construction guide server in which work plan information for constructing a predetermined system is registered, including:
a function of presenting the work plan information to the predetermined system, which is a target system, corresponding to an access from an operator terminal connected over a network, wherein
the work plan information is information based on which an operator operating the operator terminal performs a work to the target system, and includes work content information indicating work contents for constructing units constituting the target system.

15. The system construction guide server, as claimed in claim 14, wherein the work content information included in the work plan information is applicable in common when a plurality of different units are constructed.

16. The system construction guide server, as claimed in claim 14, wherein the work plan information is so configured that pieces of the work content information indicating a same work content are grouped so as to set a work plan.

17. A program for realizing, in a system construction guide server in which work plan information for constructing a predetermined system is registered, a function of presenting work plan information to the predetermined system, which is a target system, corresponding to an access from an operator terminal connected over a network, wherein
the work plan information is information based on which an operator operating the operator terminal performs a work to the target system, and indicates work contents for constructing units constituting the target system.

18. An operator terminal, connected with a system construction guide server over a network in which work plan information for constructing a predetermined system is registered, and operated by an operator performing a work to the predetermined system, which is a target system, based on the work plan information, wherein
the operator terminal has a function of requesting the work plan information to the target system by accessing the system construction guide server, and receiving it, and
the work plan information includes work content information indicating work contents for constructing units constituting the target system.

19. The operator terminal, as claimed in claim 18, wherein the work content information included in the work plan information is applicable in common when a plurality of different units are constructed.

20. The operator terminal, as claimed in claim 18, wherein the work plan information is so configured that pieces of work content information indicating a same work content are grouped so as to set a work plan.

21. A program for realizing a function of requesting work plan information with respect to a system, which is a target system, by accessing a system construction guide server and receiving it, in an operator terminal connected with the system construction guide server in which the work plan information for constructing the predetermined system is registered over a network and operated by an operator performing a work to the target system based on the work plan information, wherein
the work plan information includes work content information indicating work contents for constructing units constituting the target system.

22. A system construction guiding method for performing a system construction by using a system construction guide server in which work plan information for constructing a predetermined system is registered and an operator terminal connected with the system construction guide server over a network, the method comprising:
a work plan requesting step in which the operator terminal requests for the work plan information to the system construction guide server;
a work plan information presenting step in which the system construction guide server presents the work plan information with respect to the predetermined system, which is a target system, corresponding to a request from the operator terminal; and
a construction work step in which the operator terminal performs a work with respect to the target system connected over a network based on the work plan information presented, wherein
the work plan information includes work content information indicating work contents for constructing units constituting the target system.

23. The system construction guiding method, as claimed in claim 22, wherein the work content information included in the work plan information is applicable in common when a plurality of different units are constructed.

24. The system construction guiding method, as claimed in claim 22, wherein the work plan information is so configured that pieces of work content information indicating a same work content are grouped so as to set a work plan.
